(19) United States
(12) Patent Application Publication
(10) Pub. No.: US 2024/0273906 A1
(43) Pub. Date: Aug. 15, 2024

(54) ARTIFICIAL INTELLIGENCE SURVEILLANCE ALERTS

(71) Applicant: Cisco Technology, Inc., San Jose, CA (US)

(72) Inventors: Pete Rai, Egham (GB); Chris Shenefiel, Williamsberg, VA (US)

(21) Appl. No.: 18/108,140

(22) Filed: Feb. 10, 2023

(51) Int. Cl. G06V 20/52; G06V 10/70

(52) U.S. Cl. CPC G06V 20/52; G06V 10/70

(57) ABSTRACT

According to one or more embodiments of the disclosure, a device may obtain characteristic data of a surveillance system. The device may inspect the characteristic data of the surveillance system to identify an artificial intelligence-based service that analyzes surveillance data captured by the surveillance system. The device may generate, based on identification of the artificial intelligence-based service, an alert indicative of how the surveillance data captured by the surveillance system is being used. The device may provide the alert for presentation to one or more individuals associated with the surveillance data.

### TECHNICAL FIELD

The present disclosure relates generally to artificial intelligence surveillance alerts.

### BACKGROUND

Individuals are subject to an ever-increasing amount of sophisticated surveillance powered by artificial intelligence (AI)-based data analysis. This surveillance can occur across public, private, and semi-private settings. For instance, a user may be surveilled by a camera while at a train station, in a mall, entering an office building, etc.

Surveillance has become a ubiquitous part of modern life across a wide variety of public, private, and semi-private settings. For instance, a user may be surveilled while at a train station, a retail location, a sports arena, among other locations. Much of the recent proliferation of surveillance systems is attributable to recent advancements in the field of artificial intelligence (AI)/machine learning (ML) video analytics techniques. Indeed, AI/ML techniques now allow for the automation of various tasks that were previously left to security personnel or, in some instances, were not even possible without these techniques.

From the perspective of a person being surveilled, there is typically no insight as to the purpose of the surveillance, nor how their images are being used. These reasons can also vary widely, depending on the deployment. For instance, video analytics may be used in an airport for purposes of detecting suspected criminals or terrorists, identifying unattended luggage, and the like. In contrast, in a retail setting, video analytics may be used for purposes such as resource planning (e.g., identifying goods that need to be restocked on the shelves), training staff, improving service (e.g., identifying long checkout lines so that another register could be opened), etc. Even the operator of the establishment may not have complete knowledge as to what information is actually being collected about its patrons, nor how that information is being used. In some instances, this could even represent a legal or regulatory violation, without the knowledge of the operator.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example of a communication network;

FIG. 2 illustrates an example of a network device/node;

FIG. 3 illustrates an example of a deployment of a surveillance system;

FIG. 4 illustrates an example of an architecture for generating artificial intelligence surveillance alerts; and

FIG. 5 illustrates an example simplified procedure for generating artificial intelligence surveillance alerts.

### DESCRIPTION OF EXAMPLE EMBODIMENTS

### Overview

According to one or more embodiments of the disclosure a device may obtain characteristic data of a surveillance system. The device may inspect the characteristic data of the surveillance system to identify an artificial intelligence-based service that analyzes surveillance data captured by the surveillance system. The device may generate, based on identification of the artificial intelligence-based service, an alert indicative of how the surveillance data captured by the surveillance system is being used. The device may provide the alert for presentation to one or more individuals associated with the surveillance data.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

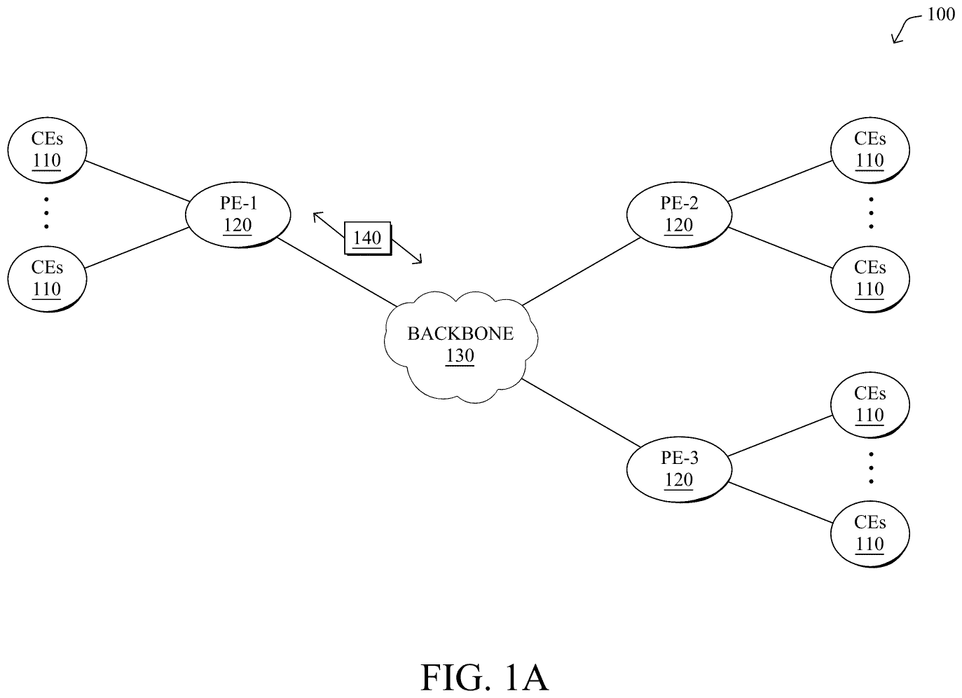

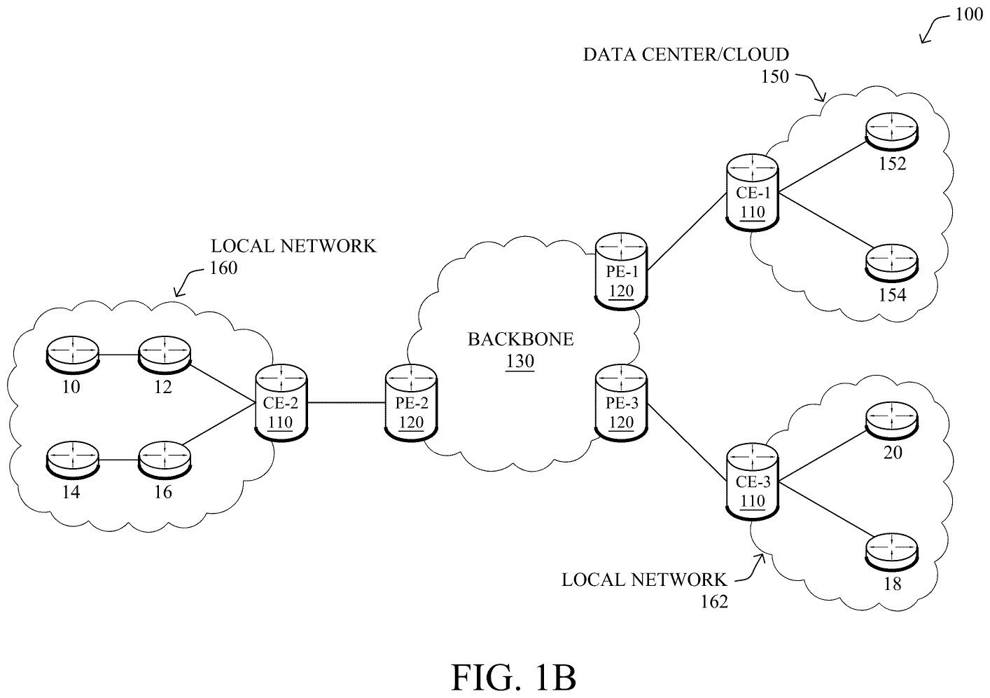

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network by the CE router via two primary links (e.g., from different Service Providers), with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection). Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

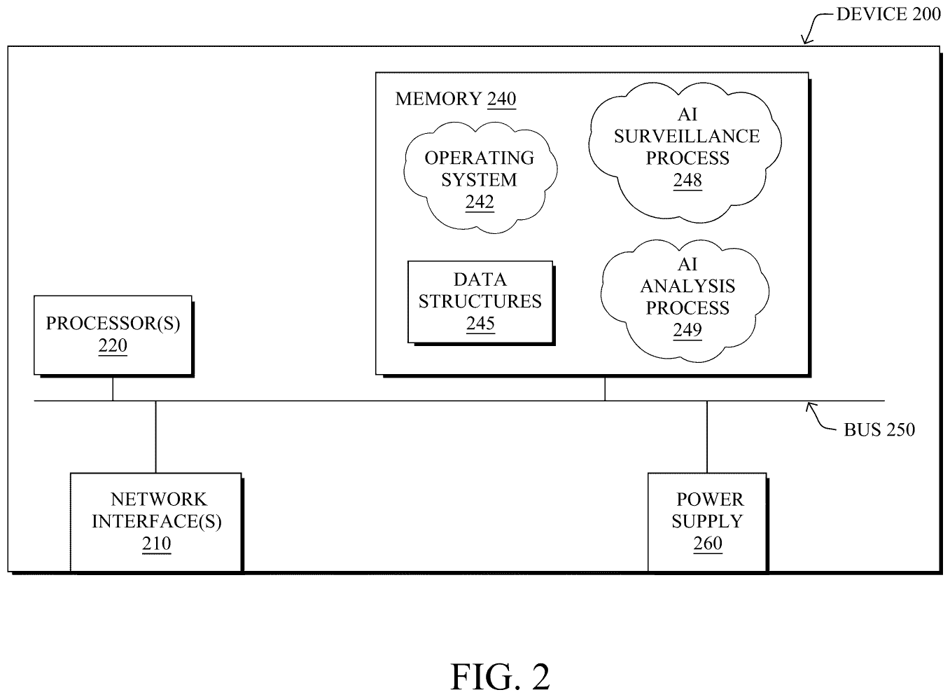

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise artificial intelligence (AI) surveillance process 248 and AI analysis process 249, as described herein, any of which may alternatively be located within individual network interfaces.

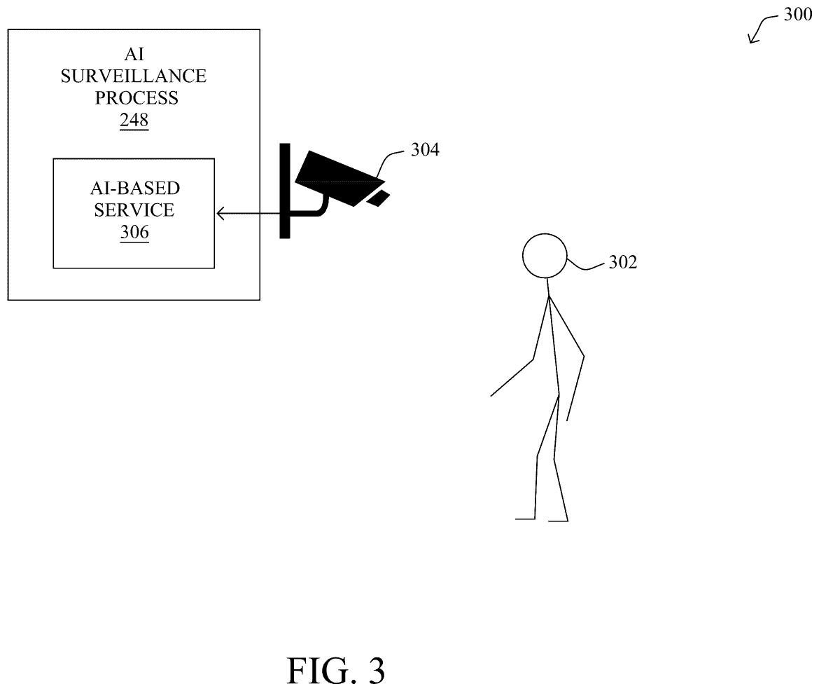

FIG. 3 illustrates an example of a deployment 300 of a surveillance system 304. Surveillance system 304 may include one or more sensors for capturing surveillance data about a subject 302 (e.g., an environment, an object, a process, a person, an event, etc.). For example, surveillance system 304 may include sensors such as one or more camera, microphone, and/or other sensor capable of collecting surveillance data about the subject 302. For instance, surveillance system 304 may include one or more camera that captures images (e.g., as part of a video feed) of subject 302 and/or one or more microphone that captures audio from subject 302.

The one or more sensors of surveillance system 304 may be subcomponents within a unitary device and/be distributed among a plurality of devices. In some examples, surveillance system 304 may include a plurality of sensors communicatively coupled with a central hub or sync module separate from the sensors.

In general, surveillance system 304 may include any device or collection of devices configured to contribute to the surveillance of a person, process, environment, object, events, etc. For example, surveillance system 304 may include a traditional security system, building management system, camera, computing device, smartphone, smart building sensor, industrial process management system, IoT device, biometric scanner, wireless access point, digital signage, etc.

During operation, surveillance system 304 may collect surveillance data from its sensors. The surveillance data may include images, audio, and/or other sensor data about a subject. The surveillance data may be stored and/or communicated for viewing and/or other use by an operator and/or a host of surveillance system 304. For example, the surveillance data may be provided to an operator entity monitoring the subject 302 by viewing the surveillance data on a display screen. As used herein, an operator of a surveillance system 304 may include an entity controlling and/or employing the surveillance system 304 to conduct surveillance of a subject 302. As used herein, a host of a surveillance system 304 may include an entity allowing the surveillance system 304 to be operated on their premises and/or with their knowledge while not necessarily consuming or viewing the surveillance data, such as a shop owner allowing a smart advertising display to be posted on their premises, etc.

Additionally, the surveillance data may be processed by AI surveillance process 248. Processing the surveillance data by AI surveillance process 248 may include communicating the surveillance data to, analyzing the surveillance data by, and/or otherwise utilizing the surveillance data by an artificial intelligence-based service, AI-based service 306, which may be provided by a specifically configured device (e.g., a device 200 through execution of AI surveillance process 248) or a combination of such devices, which may be viewed as a singular device for purposes of the teachings herein.

AI-based service 306 may include an AI-based data analysis platform for analyzing, learning from, understanding, making determinations about, and/or otherwise using surveillance data collected by surveillance system 304. For example, AI-based service 306 may utilize machine learning (ML) techniques such as deep learning, neural networks, computer vision, natural language processing, etc. to analyze and understand surveillance data from surveillance system 304 and/or to perform operations such as facial recognition, person reidentification, object tracking, person counting, anomaly detection, behavior prediction, demographic assignment, targeted marketing, predictive or understanding model development, etc. based on that analysis.

During execution, AI-based service 306 may utilize any number of learning techniques to classify the collected data, establish correspondences among the data, determine adjustments from the data, or other tasks, as described herein. Generally, AI/ML is concerned with the design and the development of techniques that receive empirical data as input (e.g., collected metric/event data from agents, sensors, etc.) and recognize complex patterns in the input data. For example, some such techniques use an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function is a function of the number of misclassified points. The learning process then operates by adjusting the parameters a,b,c such that the number of misclassified points is minimal. After this optimization/learning phase, the techniques herein can use the model M to classify new data points. Often, M is a statistical model, and the cost function is inversely proportional to the likelihood of M, given the input data.

In various embodiments, such techniques may employ one or more supervised, unsupervised, or semi-supervised learning models. Generally, supervised learning entails the use of a training set of data, as noted above, that is used to train the model to apply labels to the input data. On the other end of the spectrum are unsupervised techniques that do not require a training set of labels. Notably, while a supervised learning model may look for previously seen patterns that have been labeled as such, an unsupervised model may attempt to analyze the data without applying a label to it. Semi-supervised learning models take a middle ground approach that uses a greatly reduced set of labeled training data.

Example AI/ML techniques that may be used by AI-based service 306 may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, convolutional neural networks, etc.), support vector machines (SVMs), logistic or other regression, Markov models or chains, principal component analysis (PCA) (e.g., for linear models), multi-layer perceptron (MLP) artificial neural networks (ANNs) (e.g., for non-linear models), replicating reservoir networks (e.g., for non-linear models, typically for time series), random forest classification, or the like.

AI-based service 306 may be partially and/or fully executed by the surveillance system 304, local to surveillance system 304, at a central hub and/or sync module communicatively coupled to surveillance system 304, at a controller communicatively coupled to surveillance system 304, at an edge device communicatively coupled to surveillance system 304, remote from surveillance system 304, in a public or private cloud, in a data center, at a server, etc. In various embodiments, surveillance system 304 may provide surveillance data to AI-based service 306 for processing. In some examples, this may include communicating the surveillance data to surveillance system 304 via a data communication network, such as computer network 100 of FIGS. 1A-1B communicatively linking surveillance system 304 with AI-based service 306.

The AI-based service 306 may process the surveillance data from surveillance system 304 and/or perform operations such as facial recognition, person reidentification, object tracking, person counting, anomaly detection, behavior prediction, demographic assignment, targeted marketing, predictive or understanding model development, gate detection, automatic number-plate recognition (ANPR), etc. based on that analysis. Some of these operations may provide corresponding feature sets to the surveillance system 304 that are visible and/or exploitable by an operator of the surveillance system 304 to perform the underlying tasks. For example, some of the outputs of the AI-based service 306 operations may be provided to and/or consumable by an operator of the surveillance system.

However, many, if not all, of these operations may not be visible or consumable by a host. Further, the collection and use of the surveillance data for model development and/or data monetization may be invisible to both hosts and operators. Furthermore, the operations of the surveillance system may not be auditable by the operator and/or the host.

As noted above, the increased prevalence of surveillance systems and exploitation of the data they collect by AI has not been accompanied by an increased transparency into the data's collection and use. As a result, subjects of surveillance as well as surveillance system operators and hosts have no insight into the collection, processing, use, etc. of surveillance data.

Therefore, as users become more aware of the potential implications and impacts to their surveillance, the presently unmet demand for answers regarding the collection and use of surveillance data from surveillance systems grows. For example, a patron in a shopping center may be left wondering whether a camera is watching them, if a camera is watching them what can it see, if a surveillance system making a demographic determination about who they are, if a surveillance system can recognize them as a known individual, if their movements are being tracked, if their dwell time is being monitored, if their eye gaze is being tracked, if they are being listened to, if they are being subjected to targeted advertising, whether their images or activities are being used to train models, whether their images or activities are being monetized, etc.

Further, as the same companies established as market leaders in big data analytics, artificial intelligence, data processing, and monetization of the fruits of those endeavors increasingly become the dominant suppliers of surveillance systems, trust in how these surveillance systems collect and use surveillance data is further eroding.

Unfortunately, there is presently no mechanism to operate these surveillance systems in a transparent and auditable manner. This lack of transparency manifests further mistrust of the suppliers, operators, hosts, etc. of these systems. However, it may not be in the interest of suppliers of the surveillance systems to provide this type of transparency. For example, revealing how data is handled in their system may erode competitive advantages and expose controversial data monetization strategies.

Further, given the legislative trends toward mandating open, clear, and transparent handling of other types of user data, its feasible that this growing distrust and lack of transparency will ultimately result in further proliferation of similar such mandates for the collection and use of surveillance data. As an offshoot of this concern, non-supplier operators and/or hosts of surveillance systems may be increasingly concerned regarding their legal liabilities regarding the collection and use of surveillance data by surveillance system providers, of which they have no clear knowledge or means to audit.

### —Artificial Intelligence Surveillance Alerts—

The techniques herein introduce mechanisms for auditing AI surveillance data use capabilities of a surveillance system. The mechanisms may be utilized to retroactively determine the capabilities of an AI service in order to offer transparency to end users, to verify claims of a supplier, for legal and regulatory compliance, etc.

Illustratively, the techniques described herein may be performed by hardware, software, and/or firmware, such as in accordance with AI analysis process 249, which may include computer executable instructions executed by the processor 220 (or independent processor of interfaces 210) to perform functions relating to the techniques described herein, such as in conjunction with AI surveillance process 248.

Specifically, according to various embodiments, a device may obtain characteristic data of a surveillance system. The device may inspect the characteristic data of the surveillance system to identify an artificial intelligence-based service that analyzes surveillance data captured by the surveillance system. The device may generate, based on identification of the artificial intelligence-based service, an alert indicative of how the surveillance data captured by the surveillance system is being used. The device may provide the alert for presentation to one or more individuals associated with the surveillance data.

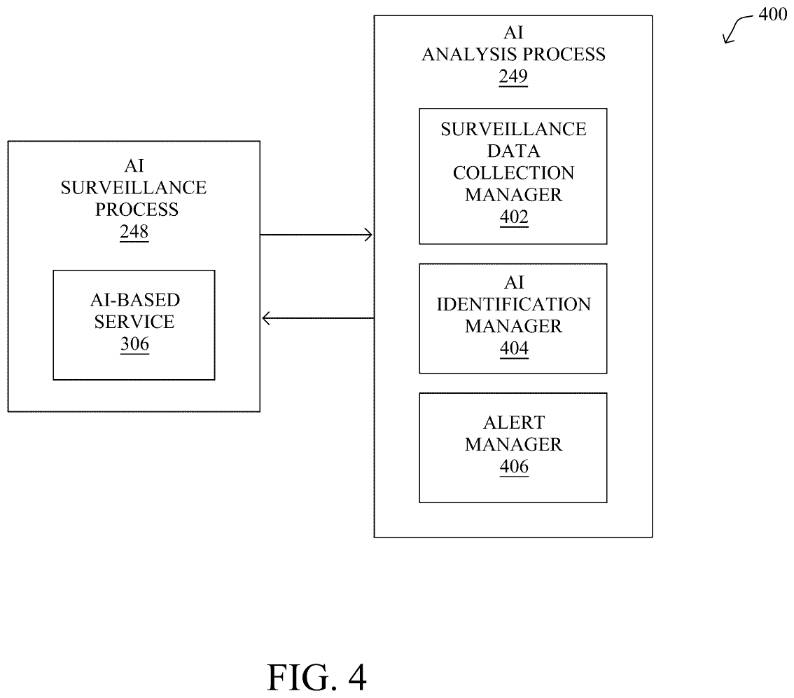

Operationally, FIG. 4 illustrates an example of an architecture 400 for generating artificial intelligence surveillance alerts, according to various embodiments. At the core of the architecture 400 is AI analysis process 249, which may be executed by a device such as a surveillance system, surveillance system component, surveillance system central hub or synch module, a surveillance system controller, a data communications network edge node local to the surveillance system, a wireless access point, a network controller, etc. In general, AI analysis process 249 may be executed to identify an AI-based service 306 that analyzes surveillance data captured by a surveillance system and to provide alerts regarding the same. Therefore, AI analysis process 249 may be executed on any device associated with the capturing, communication, processing, etc. of surveillance data and/or at a device in communication therewith.

As shown, AI analysis process 249 may include a surveillance data collection manager 402, an AI identification manager 404, and/or an alert manager 406. As would be appreciated, the functionalities of these components may be combined or omitted, as desired. In addition, these components may be implemented on a singular device or in a distributed manner, in which case the combination of executing device can be viewed as their own singular device for purposes of executing AI analysis process 249.

During execution, AI analysis process 249 may provide the ability to inspect aspects of a targeted surveillance system while in operation (e.g., during the collection and/or communication of surveillance data). In some instances, AI analysis process 249 may be hosted on and/or communicatively coupled to a device where at least a portion of the surveillance data collection, analysis, and/or communication operations associated with the surveillance system are hosted. In various embodiments, AI analysis process 249 may be hosted on and/or communicatively coupled to a device where any portion of AI surveillance process 248 is hosted. In some instances, AI analysis process 249 may operate as an add-on observer and/or auditor of the data exchange and/or process occurring between a surveillance system and a corresponding AI-based service 306 in order to determine exactly what type of data is being exchanged, processed, etc. and why.

For example, AI analysis process 249 may be configured to inspect, among other things, the configuration, processes, memory, permissions, use of peripherals, network traffic, etc. associated with the surveillance system operations at a device hosting those operations. In some instances, AI analysis process 249 may need to seek and/or be granted sufficient permissions to inspect the operations of the device and/or discover, access, and/or read any relevant data being used.

When executed, the components of AI analysis process 249 may provide insight into the operations of a surveillance system and may arrive at a determination of whether an AI feature set (e.g., AI-based service 306) is being deployed to analyze surveillance data from that surveillance system (e.g., identifying what types of data are being collected and utilized by AI-based service 306 in AI surveillance process 248). In some instances, this may be a probabilistic determination rather than a definitive one. That is, the determination may be based on observation of the configuration, resources, data collection, data communication, and data handling by the surveillance system rather than by direct knowledge of the steering logic and/or operational intents of the surveillance system. However, this may vary based on the circumstances of each deployment.

During execution, surveillance data collection manager 402 may obtain and/or inspect characteristic data of a surveillance system. The characteristic data of a surveillance system may include data indicative of the characteristics of the underlying operations by the surveillance system and/or of an AI-based service 306. For example, the characteristic data may include data that is associated with a particular type of activity, communication, resource usage, operating configuration, type of network traffic, etc. of the surveillance system and/or a corresponding AI-based service 306.

For instance, characteristic data may include data indicative of camera use (e.g., image collection, image communication, image analysis, etc.) by a surveillance system and/or a corresponding AI-based service 306. Camera use may be an important modality in determining whether a surveillance system and/or the corresponding AI-based service 306 is watching subjects (e.g., person, process, environment, object, events, etc.).

Characteristic data indicative of camera use may include data indicative of the presence and/or use of a camera. In addition, characteristic data indicative of camera use may include data indicative of a permission of a target system and/or AI-based service 306 to access and/or use the camera. The permission data may provide a more robust and powerful indication of how and/or when that camera is being operated and how and/or when the surveillance data it is collecting is being used. These types of permissions may be managed by the operating system and/or computing environment. Therefore, in some instances, surveillance data collection manager 402 may obtain this type of characteristic data from the operating system and/or computing environment hosting the surveillance system operations.

Characteristic data indicative of camera use may also be derived by surveillance data collection manager 402 through examination of the libraries which are being utilized for surveillance system operations. For example, characteristic data indicative of camera use may include use of and/or access to known image processing libraries by the surveillance system and/or the corresponding AI-based service 306, which can provide a firm indication that images captured by the camera are being processed.

Further, characteristic data indicative of camera use may include data extracted from observation of network data traffic. For example, by inspecting network traffic to and/or from the surveillance system and/or its components, surveillance data collection manager 402 may retrieve characteristic data indicative of whether a camera is in operation and/or how its images are being used.

For instance, characteristic data indicative of various network traffic protocol usage, such as real time streaming protocol (RTSP), hypertext transfer protocol (HTTP) streaming, etc., that is retrieved from inspecting network traffic may be indicative of whether a camera is in operation and/or how its images are being used. Similarly, characteristic data indicative of common network models for communicating video, such as adaptive bitrate, etc., that are retrieved from inspecting network traffic may be indicative of whether a camera is in operation and/or how its images are being used. Characteristic data indicative of video data container formats, such as transport streams and MP4, that are retrieved from inspecting network traffic may be indicative of whether a camera is in operation and/or how its images are being used.

Additionally, characteristic data may include data indicative of microphone use (e.g., audio collection, audio communication, audio analysis, etc.) by a surveillance system and/or a corresponding AI-based service 306. Microphone use may be another important modality in determining whether a surveillance system and/or a corresponding AI-based service 306 is listening to subjects (e.g., people, environment, objects, events, etc.); a concern which may also loom large in future regulatory requirements.

Characteristic data indicative of microphone use may include data indicative of the presence and/or activity of a microphone. In addition, characteristic data indicative of microphone use may include data indicative of a permission of a target system and/or its corresponding AI-based service 306 to access and/or use the microphone. The existence and/or use of such permissions may provide a more robust and powerful indication of how and/or when that microphone is being operated and how and/or when the surveillance data that is collected is ultimately being used. Like the camera permissions, these types of permissions for the microphone may be managed by the operating system and/or computing environment. Therefore, in some instances, surveillance data collection manager 402 may obtain this type of characteristic data from the operating system and/or computing environment hosting the surveillance system operations.

Like the characteristic data indicative of camera use, characteristic data indicative of microphone use may include data indicative of the use of specific audio libraries, protocols, methods, container formats, etc. that indicate whether a microphone is in operation and/or how its audio data is being used or communicated. Therefore, as is the case with the characteristic data indicative of camera use, surveillance data collection manager 402 may retrieve characteristic data indicative of microphone use by inspection of library permissions/usage, network data traffic, etc. associated with surveillance system operations.

Various other types of characteristic data may be obtained by surveillance data collection manager 402. For instance, surveillance data collection manager 402 may obtain characteristic data indicative of AI-based service 306 operations. Characteristic data indicative of AI-based service 306 operations may include data indicative of the existence, use, access, permission, etc. of libraries and/or interfaces associated with performing particular AI-based service 306 operations and that are therefore indicative of their deployment. For example, characteristic data indicative of AI-based service 306 operations may include the detection of a known facial detection library installed and/or in use on the surveillance system and/or a device that is hosting operations of the surveillance system. Similar such libraries exist for a wide variety of AI-based services including facial recognition, person reidentification, object tracking, person counting, anomaly detection, behavior prediction, demographic assignment, targeted marketing, predictive or understanding model development, gate detection, automatic number-plate recognition (ANPR), etc. The use of open libraries, while significantly reducing the development costs of AI-based services and surveillance systems, may inadvertently leak information about surveillance data use cases to surveillance data collection manager 402.

In a similar approach to the identification of the existence of, use of, access of, permission to, etc. libraries associated with AI-based service 306, surveillance data collection manager 402 may obtain characteristic data indicative of data exchange with AI-based service 306. Characteristic data indicative of data exchange with AI-based service 306 may include data indicative of communication of surveillance data to AI-based service 306 such as one hosted remote from the surveillance system (e.g., in a public or private cloud, in a data center, at a server, at an edge device, etc.). In various instances, the static libraries mentioned in earlier examples of sources of characteristic data may have corresponding cloud-based variants, the data exchange with which may be identified. The use of these ancillary remotely hosted AI-based services, while significantly reducing the development costs of AI-based services and surveillance systems, also may inadvertently leak information about surveillance data use cases to surveillance data collection manager 402.

During execution, AI identification manager 404 may inspect the characteristic data obtained by surveillance data collection manager 402 in order to identify whether an AI-based service 306 is analyzing surveillance data captured by the surveillance system. As previously mentioned, this determination may be a probabilistic one rather than a definitive one. That is, AI identification manager 404 may utilize the clues leaked as characteristic data to identify a probability of AI-based service involvement rather than by a direct confirmation or declaration from the surveillance system and/or its supplier. In this manner, AI analysis process 249 may, in some instances, serve as a third-party auditing tool to audit the activities of the surveillance system by observation of its activity (e.g., AI surveillance process 248, AI-based service 306, etc.).

For example, AI identification manager 404 may identify whether an AI-based service 306 is analyzing surveillance data captured by the surveillance system based on its inspection of characteristic data indicative of camera use. For instance, AI identification manager 404 may identify that an AI-based service 306 is analyzing surveillance data captured by a camera the surveillance system when it detects, by its inspection of the characteristic data, the presence and/or operation of a camera by the surveillance system and/or a device hosting an operation of the surveillance system. In various embodiments, AI identification manager 404 may identify that an AI-based service 306 is analyzing surveillance data captured by a camera of the surveillance system when it detects, by its inspection of the characteristic data, the existence or use of permissions of a target system and/or AI-based service 306 to access and/or use the camera and/or the surveillance data collected by the camera.

Further, AI identification manager 404 may identify that an AI-based service 306 is analyzing surveillance data captured by a camera of the surveillance system when it detects, by its inspection of the characteristic data, the existence, use, etc. of known image processing libraries by the surveillance system and/or a device hosting an operation of the surveillance system. Furthermore, AI identification manager 404 may identify that an AI-based service 306 is analyzing surveillance data captured by a camera of the surveillance system when it detects, by its inspection of the characteristic data from network data traffic, the use of protocols associated with real time image feeds, network models associated with video communication, video data container formats, etc.

In addition, AI identification manager 404 may identify that an AI-based service 306 is analyzing surveillance data captured by a camera of the surveillance system based on a comparison of the characteristic data obtained by surveillance data collection manager 402 during the operation of the surveillance system to data obtained during test operations. For example, AI identification manager 404 may utilize characteristic data from a known and/or test use of a camera of the surveillance system, a different camera (e.g., separately deployed from the surveillance system for testing purposes, etc.) from the camera of the surveillance system, etc. as a reference data set for comparison. For instance, by comparing the traffic flowing during a test use of a camera with a known operational purpose to the traffic flowing on a target system performing surveillance system operations, AI identification manager 404 may be able to identify similarities and/or differences indicative of an AI-based service 306 obtaining and/or analyzing surveillance data captured by the camera of the surveillance system. In some instances, AI analysis process 249 may utilize a separately deployed and/or dedicated camera for temporary use in collecting such traffic for comparison.

In various embodiments, AI identification manager 404 may determine a field of view of a camera of the surveillance system. This may be achieved by traffic observation and/or comparison of the test camera when a subject is in its field of view as compared to the camera of the surveillance system. By mapping the location of a subject in a field of view of a test camera when traffic indicating that a subject is in the field of view is present at the surveillance system and/or a corresponding AI-based service 306, AI identification manager 404 may determine a field of view of a camera of the surveillance system. This may allow AI identification manager 404 to identify when a subject is within the visible range of the camera of the surveillance system, thereby indicating when alerts, discussed in greater detail below, may be relevant to particular subjects.

AI identification manager 404 may identify whether an AI-based service 306 is analyzing surveillance data captured by a microphone of the surveillance system based on its inspection of characteristic data indicative of microphone use. For instance, AI identification manager 404 may identify that an AI-based service 306 is analyzing surveillance data captured by a microphone of the surveillance system when it detects, by its inspection of the characteristic data, the presence and/or operation of a microphone by the surveillance system and/or by a device hosting an operation of the surveillance system. In various embodiments, AI identification manager 404 may identify that an AI-based service 306 is analyzing surveillance data captured by a microphone of the surveillance system when it detects, by its inspection of the characteristic data, permissions of a target system and/or AI-based service 306 to access and/or use the microphone and/or the surveillance data collected by the microphone.

AI identification manager 404 may also identify that an AI-based service 306 is analyzing surveillance data captured by a microphone of the surveillance system when it detects, by its inspection of the characteristic data, the existence, use, etc. of audio processing libraries by the surveillance system and/or by a device hosting an operation of the surveillance system. Furthermore, AI identification manager 404 may identify that an AI-based service 306 is analyzing surveillance data captured by a microphone of the surveillance system when it detects, by its inspection of the characteristic data from network data traffic, the use of protocols associated with real time audio feeds, network models associated with audio communication, audio data container formats, etc.

In addition, AI identification manager 404 may identify that an AI-based service 306 is analyzing surveillance data captured by a microphone of the surveillance system based on a comparison of the characteristic data obtained by surveillance data collection manager 402 during the operation of the surveillance system to data obtained during test operations. For example, AI identification manager 404 may attempt to establish a correlation between sounds in the environment and characteristic data captured and/or communicated from the surveillance system and/or a device hosting an operation of the surveillance system. This may be accomplished by employing a sound generating device to deploy a test sound in the environment under surveillance in concert with inspection of traffic flow of the surveillance system, AI-based service 306, and/or a device hosting an operation of the surveillance and/or AI-based service 306. The correlation may be established between the system and/or network traffic visible to AI identification manager 404 while the test sound is being generated versus not being generated.

AI identification manager 404 may identify that an AI-based service 306 is analyzing surveillance data captured by the surveillance system when it detects, by its inspection of the characteristic data, data indicative of AI-based service 306 operations. For example, AI identification manager 404 may identify that an AI-based service 306 is analyzing surveillance data captured by the surveillance system when it detects, by its inspection of the characteristic data, the existence, use, access, etc. of libraries and/or interfaces associated with deployment and/or performance of particular operations of AI-based service 306. For example, AI identification manager 404 may identify that an AI-based service 306 is analyzing surveillance data captured by the surveillance system when it detects, by its inspection of the characteristic data, the existence, use, access, etc. of known facial detection, gate detection, face recognition, ANPR, person reidentification, object tracking, person counting, anomaly detection, behavior prediction, demographic assignment, targeted marketing, predictive or understanding model development etc. libraries installed and/or in use on the surveillance system and/or on the device performing operations for the surveillance system.

Similarly, AI identification manager 404 may identify that an AI-based service AI-based service 306 is analyzing surveillance data captured by the surveillance system when it detects, by its inspection of the characteristic data, the use of, access of, data exchange with, etc. an AI-based service 306 such as those hosted remotely from the surveillance system.

AI identification manager 404 may also derive hours of operation of a surveillance system, its surveillance data capturing components, an AI-based service 306, and/or any surveillance data exchange between a surveillance system and an AI-based service 306. The hours of operation of a surveillance system and/or a corresponding AI-based service 306 may provide valuable insight into the operations of the system.

For example, a surveillance system and/or a corresponding AI-based service 306 for targeted advertising in a shopping center may be required to shut down after the stores have closed. Likewise, a surveillance system and/or a corresponding AI-based service 306 for building systems management in a workplace may be required to not operate after the workday is over. Other such temporal operating boundaries may exist within a given deployment as well.

AI identification manager 404 may utilize a variety of techniques to derive information about the actual hours of use of a target system. For example, AI identification manager 404 may compare the characteristic data and/or other metrics obtained from the surveillance system and/or device performing operations for the surveillance system while the system is operating in its allowed operational time period to the characteristic data and/or other metrics obtained when the system is not supposed to be operating in order to determine the hours of operation. Example metrics which may be useful in determining hours of operation may include processes, memory, network, usage patterns, power, etc.

During execution, alert manager 406 may generate and/or provide alerts indicative of how the surveillance data captured by the surveillance system is being used. The alerts may be generated based on the determinations of AI identification manager 404. For example, the alerts may include a characterization of any identification by AI identification manager 404 that an AI-based service 306 is receiving and/or analyzing surveillance data captured by the surveillance system. Alert manager 406 may provide the alert for presentation to one or more individuals associated with the surveillance data.

For example, alert manager 406 may provide the alert directly to subjects of the surveillance. For instance, alert manager 406 may output its findings to subjects passing by the surveillance system and/or entering an area under surveillance by the surveillance system. Alert manager 406 may identify subjects under surveillance by proximity limited alert communication, communication of alerts to subjects identified as being within the field of view of a camera, communication of alerts to subjects identified as being within the reach of a microphone, communication of alerts to subjects identified as being within the range of a sensor, etc.

For example, AI identification manager 404 may provide the alert by causing the display of a location, field of view of camera, a microphone reach, range of detection by sensor, detected capabilities, etc. of the surveillance system to be displayed to a subject. The display may include information or warnings to the subject such as “this camera has an open microphone.”

The alert may be provided by causing its display on a screen which is proximate to the surveillance system. Additionally, or alternatively, the alert may be provided by causing its display on a personal device of the subject such as on a smartphone screen by pushing the alert to smartphones within a particular proximity to the surveillance system.

Additionally, alert manager 406 may provide the alert indirectly to subjects of the surveillance. For example, alert manager 406 may indirectly output its findings via the use of a webpage, which is accessible when close to the surveillance system and/or when distant from it. The webpage uniform resource locator (URL) may be shown when in proximity of the surveillance system and/or may be made available on a centralized index. In some instances, access to the webpage may be provided via a QR code or other encoding mechanism displayed nearby the surveillance system.

Alert manager 406 may provide the alert for incorporation in a general index of device capabilities. For instance, alert manager 406 may contribute its alerts to a general index of capabilities of surveillance systems in a particular geographic area. This index may then be utilized to overlay information graphics onto a mapping application. These types of mappings may be utilized for searching surveillance systems by geography and/or capability. Further, these types of mappings may be utilized for navigation applications to find routes which avoid devices with certain capabilities.

In various embodiments, alert manager 406 may provide the alert for incorporation in a compliance report. For example, alert manager 406 may provide the output of the inspection by AI identification manager 404 for incorporation into a compliance report such as when the surveillance system capabilities and/or operational behavior need to be declared for contractual reasons, regulatory reasons, etc. Suppliers may use these alerts to publish such compliance reports to give assurances to potential buyers. Further, regulators may require such compliance reports to grant legal clearance. Furthermore, purchasers, operators, and/or hosts may use such compliance reports to check that suppliers are correctly representing the capabilities and/or operational behavior of their devices.

AI analysis process 249 may, through the aforementioned operations, empower hosts of surveillance systems and subjects of surveillance with greater visibility as to how a subject's data is being used by surveillance systems (e.g., by an AI-based service 306 of AI surveillance process 248). By monitoring and/or detecting active algorithms, API calls, etc., AI analysis process 249 can infer this data usage without granular inspection of a surveillance system's code. As processing continues to migrate to the edge, this type of inferential auditing may become even more relevant as it is increasingly visible by observation.

Beneficially, the described inferential auditing mechanism may provide this visibility into the operations of a surveillance system without introducing additional vulnerability to the surveillance system and/or its surveillance data. For example, monitoring a surveillance system's behavior, such as API usage, according to the various disclosed embodiments may enable inference of the operations of a surveillance system without accessing the sensitive data directly.

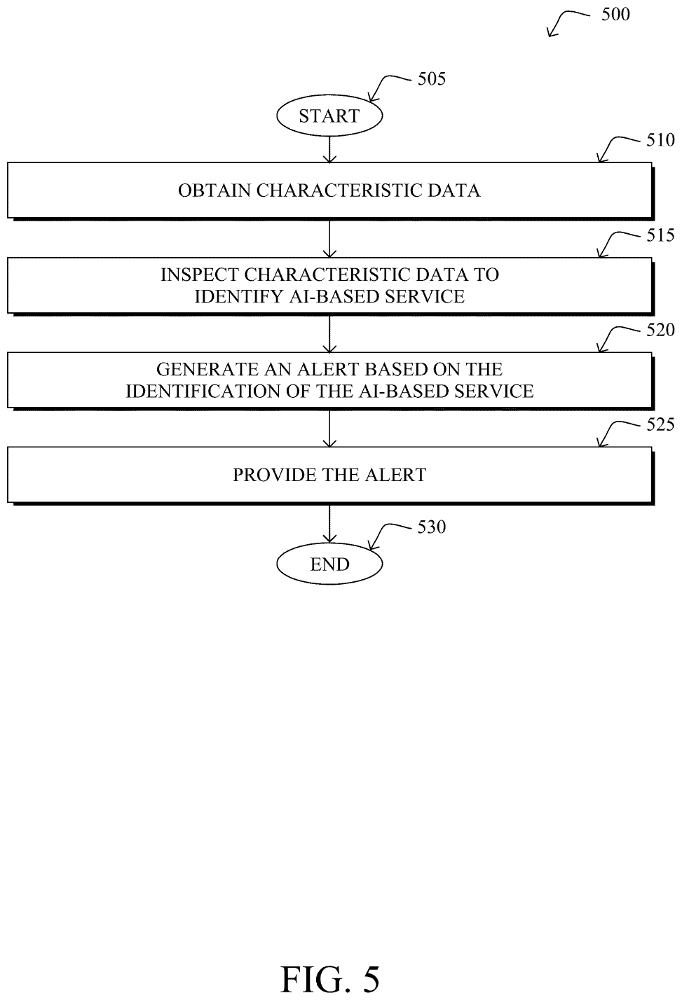

FIG. 5 illustrates an example simplified procedure (e.g., a method) for generating artificial intelligence surveillance alerts, in accordance with one or more embodiments described herein. For example, a non-generic, specifically configured device (e.g., device 200), may perform procedure 500 by executing stored instructions (e.g., AI analysis process 249). The procedure 500 may start at step 505, and continues to step 510, where, as described in greater detail above, a device may obtain characteristic data of a surveillance system.

The characteristic data may be indicative of network traffic associated with the surveillance system. Additionally, the characteristic data may be indicative of the network traffic associated with the surveillance system. The characteristic data may be indicative of the network traffic comprising a particular application programming interface (API) call associated with the artificial intelligence-based service.

The characteristic data may also be indicative of a schedule at which the surveillance data is sent to the artificial intelligence-based service for analysis. For example, the characteristic data may be present and/or detectable in a particular configured while the surveillance data is being sent to the artificial intelligence-based service for analysis. In this manner, the characteristic data may reveal when a surveillance system is sending surveillance data to an artificial intelligence-based service for analysis and/or when it is not.

In various embodiments, the characteristic data may be indicative of one or more libraries used by the surveillance system. In some instances, these libraries may be libraries associated with artificial intelligence-based analysis of various types of surveillance data.

At step 515, as detailed above, the device may inspect the characteristic data of the surveillance system to identify an artificial intelligence-based service that analyzes surveillance data captured by the surveillance system. For example, the device may inspect characteristic data to identify characteristic data indicative of communication of surveillance data to, analysis of surveillance data by, and/or access to surveillance data by an artificial intelligence-based service.

At step 520, as detailed above, the device may generate, based on the artificial intelligence-based service, an alert indicative of how the surveillance data captured by the surveillance system is being used. The alert may indicate that the surveillance data is being used for at least one of: facial recognition, person reidentification, object tracking, person counting, or anomaly detection.

At step 525, where, as detailed above, the device may provide the alert for presentation to one or more individuals associated with the surveillance data. The device may provide the alert for display by a display located in a location associated with the surveillance data (e.g., same geographic location, same building, same room, etc.). The alert may be provided as part of a compliance report for the surveillance system. In further examples, the alert may be provided as part of a map.

Procedure 500 then ends at step 530.

It should be noted that while certain steps within procedure 500 may be optional as described above, the steps shown in FIG. 5 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, introduce mechanism for inferential auditing of surveillance system operations and AI-based feature sets for analyzing surveillance data. The mechanisms may be utilized to determine the capabilities of a surveillance system and/or its AI-based service components by observation of the capabilities, configurations, operations, and/or communications of those systems. These techniques may provide minimally invasive and secure mechanisms of gathering insights into the operations of a surveillance system and/or its AI-based service components in order to offer transparency to end users, to verify claims of a supplier, for legal and regulatory compliance, etc.

While there have been shown and described illustrative embodiments that provide artificial intelligence surveillance alerts, it is to be understood that various other adaptations and modifications may be made within the spirit and scope of the embodiments herein. For example, while certain embodiments are described herein with respect to using the techniques herein for certain purposes, the techniques herein may be applicable to any number of other use cases, as well. In addition, while certain types of surveillance system components and surveillance data are discussed herein, the techniques herein may be used in conjunction with any surveillance system component and/or surveillance data.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
obtaining, by a device, characteristic data of a surveillance system;
inspecting, by the device, the characteristic data of the surveillance system to identify an artificial intelligence-based service that analyzes surveillance data captured by the surveillance system;
generating, by the device and based on identification of the artificial intelligence-based service, an alert indicative of how the surveillance data captured by the surveillance system is being used; and
providing, by the device, the alert for presentation to one or more individuals associated with the surveillance data.

2. The method as in claim 1, wherein the characteristic data is indicative of network traffic associated with the surveillance system.

3. The method as in claim 2, wherein the characteristic data is indicative of the network traffic comprising audio data.

4. The method as in claim 2, wherein the characteristic data is indicative of the network traffic comprising a particular application programming interface (API) call associated with the artificial intelligence-based service.

5. The method as in claim 1, wherein the device provides the alert for display by a display located in a location associated with the surveillance data.

6. The method as in claim 1, wherein the characteristic data is indicative of a schedule at which the surveillance data is sent to the artificial intelligence-based service for analysis.

7. The method as in claim 1, wherein the characteristic data is indicative of one or more libraries used by the surveillance system.

8. The method as in claim 1, wherein the alert indicates that the surveillance data is being used for at least one of: facial recognition, person reidentification, object tracking, person counting, or anomaly detection.

9. The method as in claim 1, wherein the alert is provided as part of a compliance report for the surveillance system.

10. The method as in claim 1, wherein the alert is provided as part of a map.

11. An apparatus, comprising:
one or more network interfaces;
a processor coupled to the one or more network interfaces and configured to execute one or more processes; and
a memory configured to store a process that is executable by the processor, the process when executed configured to:
obtain characteristic data of a surveillance system;
inspect the characteristic data of the surveillance system to identify an artificial intelligence-based service that analyzes surveillance data captured by the surveillance system;
generate, based on identification of the artificial intelligence-based service, an alert indicative of how the surveillance data captured by the surveillance system is being used; and
provide the alert for presentation to one or more individuals associated with the surveillance data.

12. The apparatus as in claim 11, wherein the characteristic data is indicative of network traffic associated with the surveillance system.

13. The apparatus as in claim 12, wherein the characteristic data is indicative of the network traffic comprising audio data.

14. The apparatus as in claim 12, wherein the characteristic data is indicative of the network traffic comprising a particular application programming interface (API) call associated with the artificial intelligence-based service.

15. The apparatus as in claim 11, wherein the alert is provided for display by a display located in a location associated with the surveillance data.

16. The apparatus as in claim 11, wherein the characteristic data is indicative of a schedule at which the surveillance data is sent to the artificial intelligence-based service for analysis.

17. The apparatus as in claim 11, wherein the characteristic data is indicative of one or more libraries used by the surveillance system.

18. The apparatus as in claim 11, wherein the alert indicates that the surveillance data is being used for at least one of: facial recognition, person reidentification, object tracking, person counting, or anomaly detection.

19. The apparatus as in claim 11, wherein the alert is provided as part of a compliance report for the surveillance system.

20. A tangible, non-transitory, computer-readable medium storing program instructions that cause a device to execute a process comprising:
obtaining, by the device, characteristic data of a surveillance system;
inspecting, by the device, the characteristic data of the surveillance system to identify an artificial intelligence-based service that analyzes surveillance data captured by the surveillance system;
generating, by the device and based on identification of the artificial intelligence-based service, an alert indicative of how the surveillance data captured by the surveillance system is being used; and
providing, by the device, the alert for presentation to one or more individuals associated with the surveillance data.
